(19) United States
(12) Patent Application Publication
(10) Pub. No.: US 2006/0093382 A1
(43) Pub. Date: May 4, 2006

(54) System and method for accurately tracking printable material

(76) Inventors: John P. Ertel, Half Moon Bay, CA (US); Tong Xie, San Jose, CA (US); Marshall T. DePue, San Mateo, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/980,401

(22) Filed: Nov. 3, 2004

(51) Int. Cl. G03G 15/00

(52) U.S. Cl. 399/16

(57) ABSTRACT

Systems for the accurate rendering of printed material are disclosed. A system may comprise a substrate, a roller in close contact with the substrate, and a motion sensor that tracks the motion of the roller. A substrate is advanced by an advancement mechanism towards a printing mechanism, and a roller is placed in contact with the substrate so that movement of the substrate results in movement of the roller. Optical and/or motion sensors may be used to track the motion of the roller. In some embodiments, more than one motion sensor may be used to track the motion of the ball roller in more than one plane of movement.

### FIELD OF THE INVENTION

The invention relates generally to systems and methods for rendering printable material, and more specifically to the use of optical motion sensors to accurately track printable material.

### BACKGROUND OF THE INVENTION

Various techniques are in use that allow for the rendering of printed material by automated printing, scanning, copying, transmission, and generation devices. Instruments such as, for example, typewriters, thermal printers, inkjet printers, printing presses, laser printers, plotters, and typesetting machines, can all generate printed substrates consisting of, for example, text and/or images. Scanners, copiers, and facsimile machines can be used to generate and/or transmit electronic versions of printed substrates. The printed substrate used may be monochromatic or multi-color depending on the requirements of an end-user. For maximum utility, printed text and/or images should be located accurately on a printed substrate to ensure desirable characteristics such as readability, attractiveness, and overall clarity.

Accurate positioning of a substrate is generally a desired characteristic of instruments such as printers, scanners, copiers, and facsimile machines. Accurate positioning of the substrate may employ mechanical positioning systems using, for example, cogged wheels in contact with the substrate. However, many mechanical solutions are not accurate enough for images requiring fine detail and correspondingly fine positioning of the substrate. Also, the precision of these mechanical systems may not allow for reproducibility if multiple copies of printed material are desired.

Instruments that use drive motors, wheels, or rollers in contact with a substrate may infer the position of the substrate from movement of the drive motors, wheels, or rollers. For example, one prior art solution uses a shaft encoder coupled to a drive motor shaft. Rotation of the drive shaft is used to approximate the movement of a substrate with which the shaft is in contact. However, any variances in the diameter of the drive shaft result in inaccurate approximations of the substrate movement. If the drive shaft is of smaller than nominal diameter, it will advance the substrate less than desired for a given amount of shaft angular rotation. Additionally, if the drive shaft rotates about a center with an eccentric error, the approximated substrate movement may have a periodic error that may be large or small depending on the magnitude of the eccentricity.

Inkjet printers that use shaft encoders are particularly susceptible to image distortions and errors caused by substrate movement. Ideally, the substrate is advanced exactly the distance needed to match the inkjet nozzle pattern produced during a previous pass of the printing head. If the distance advanced is correct, seamless printed material is produced. However, if the method used to approximate the movement of the substrate is not accurate, inaccuracies in the printed material will result. If the substrate is not advanced enough, the inkjet printing head will produce a dark band across the substrate where there is overlap with the previous printing pass. If the paper is advanced too far, there will be a gap between printing passes where the printing head did not deposit ink. Also, cumulative printing errors can result in distortion of images. For example, a printed circle may appear elliptical due to accumulated error in the approximation of the printing substrate advancement.

Solutions are needed that accurately and precisely track the movement of a substrate. Accurate tracking of substrate movement may ensure that printed material is rendered with the desired quality characteristics. Accurate substrate tracking may also ensure that, for example, printed text and/or images are located in the desired location on a printing substrate. Also, precision tracking may provide for reproducible duplication of printed material in, for example, a copier or scanner.

### BRIEF SUMMARY OF THE INVENTION

The present disclosure is directed to systems and methods which accurately allow a printed substrate to be rendered. One embodiment comprises a method for accurately tracking the position of a substrate that provides a substrate and advances the substrate towards a printing mechanism a predetermined distance. The actual distance advanced by the substrate is then measured by a motion sensor, and the position of the substrate may then be adjusted if the actual distance advanced does not equal the predetermined distance. The difference between the actual distance advanced and the predetermined distance can be used to calibrate a system. Both optic and magnetic motion sensors are disclosed.

In one embodiment, a system for accurate rendering is achieved by using a substrate, a roller in close contact with the substrate, and an optical motion sensor that tracks the motion of the roller. The roller is patterned to allow the optical motion sensor to more easily track the motion of the roller. The optical motion sensor of the embodiment consists of a light source and a sensor. In other embodiments, more than one roller may be used in combination with more than one optical motion sensor.

In other embodiments, a substrate is advanced by an advancement mechanism towards a printing mechanism. A ball roller is placed in contact with the substrate so that movement of the substrate results in movement of the roller. An optical motion sensor is used to track the motion of the roller. In some embodiments, more than one motion sensor may be used to track the motion of the ball roller in more than one plane of movement.

In still another embodiment, a substrate is advanced towards a scanning head by an advancement mechanism. A two-axis roller system is included with one roller being used to track the movement of the substrate in one plane, while a second roller is being used to track the movement of the substrate in another plane. In some embodiments, a third roller may be used in a three-plane system.

Other embodiments of the invention may use magnetic detectors such as magnetometers to detect magnetic materials and magnets embedded in or attached to the surface of a roller in contact with an advancing substrate. Electromagnets may also be incorporated into the roller.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates one embodiment in which a tension roller and an intermediate roller are used to provide accurate image rendering;

FIG. 2 illustrates one embodiment of an accurate image rendering system including a printing head and/or a ball roller;

FIG. 3 illustrates an embodiment of an accurate image rendering system including a scanning head;

FIG. 4 is a flow diagram of a method according to an embodiment of the present invention; and

FIG. 5 is an illustration of an embodiment of the invention with a magnetic pattern recognition pickup.

### DETAILED DESCRIPTION OF THE INVENTION

FIG. 1 illustrates one embodiment in which a tension roller and an intermediate roller are used to provide accurate image rendering. Tension roller 101 of system 10 may be a cylindrical roller rotatable around its longitudinal axis. Tension roller 101 may have a surface that maintains high friction with substrate 102. Such a surface may be comprised of rubber or rubber products, polymer material, wood, plastic, or other materials. Surface materials with a high friction coefficient may be especially suitable for use with embodiments of the present invention.

Substrate 102 may comprise printed material such as, for example, text, pictures, images, paintings, handwriting, photographs, etc. In one embodiment, substrate 102 is paper and/or paper products such as, for example, cardboard, construction paper, photo paper. In other embodiments, substrate 102 is plastic, polymer, or cellulose products such as, for example, transparency films, photographic film, x-ray films. In yet other embodiments, substrate 102 is metal such as, for example, aluminum, steel, or metal alloys. Other substrates utilizing compounds comprised substantially of carbon, minerals, and other flexible and non-flexible materials capable of hosting printed text and/or images are used with some embodiments.

Intermediate roller 103 is in constant contact with substrate 102 such that the surface of intermediate roller 103 moves at the same speed as does substrate 102. The surface of intermediate roller 103 may be selected to provide optimal friction with substrate 102 and thereby will move at the same speed as substrate 102. Intermediate roller 103 is a grit wheel in certain embodiments with excellent traction and repeatability, and may be driven if desired. In one embodiment shown intermediate roller 103 is not driven, but is allowed to move freely according to the movement of substrate 102. Intermediate roller 103 is constructed having a pattern recognizable by optical means. Such a pattern may be drawn on the roller or created using different colored materials. A pattern may also be generated by etching the surface of intermediate roller 103 or by adding ridges or raised portions.

Motion sensor 104 is comprised of light source 105 and sensor 106. Motion sensor 104 may be similar to that described in U.S. Pat. No. 5,149,980 granted to Ertel et al. Motion sensor 104 infers motion of substrate 102 by monitoring motion of intermediate roller 103. The surface of intermediate roller 103 may be selected in some embodiments to provide an optimum signal to sensor 106. Such a surface may include a patterned or quasi-patterned surface. Light source 105 may be monochromatic, such as a laser light source, or may be chromatic light from a light bulb or other broad-spectrum source. Light source 105 may, if desired, be a light-emitting diode (LED). Light source frequency can vary and is selected to produce optimum signal strength and tracking correlation to sensor 106. Sensor 106, in one embodiment, can be a photovoltaic sensor that produces electric current in response to photon stimulation by a light source. Sensor 106 is positioned to receive reflected light from light source 105 via the surface of intermediate roller 103. In some embodiments, variations in the signal strength generated by sensor 106 may be correlated to motion of intermediate roller 103.

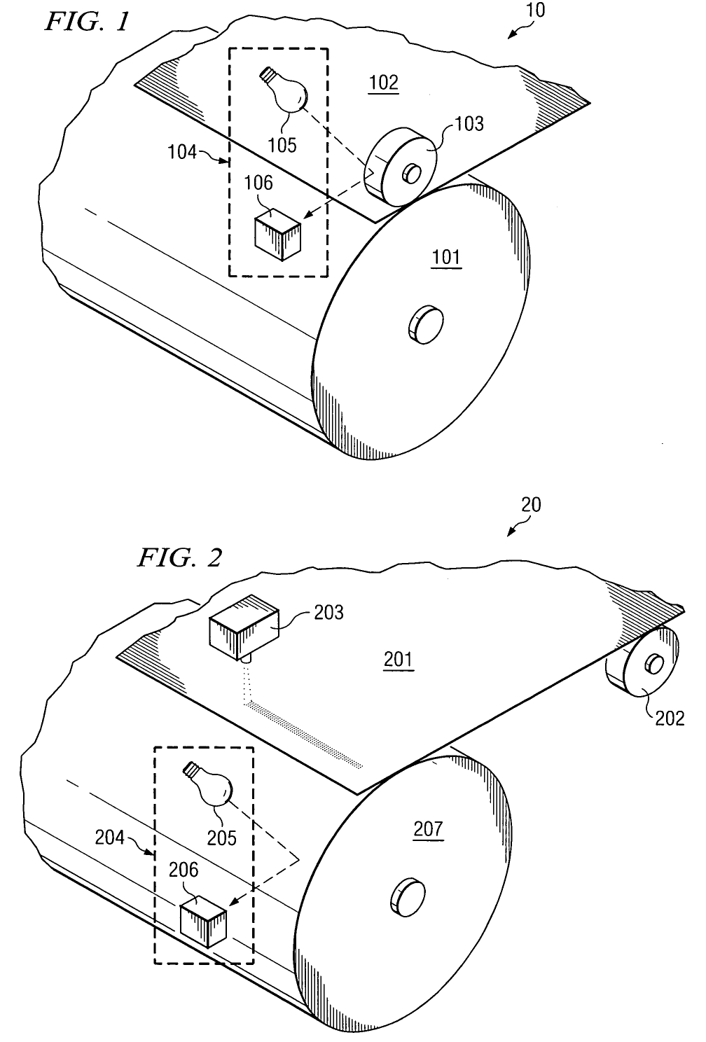

FIG. 2 illustrates one embodiment of an accurate image rendering system including a printing head and/or a ball roller. Substrate 201 may be advanced by advancement mechanism 202 towards printing mechanism 203. Substrate 201 is paper and/or paper products in certain embodiments, such as, for example, cardboard, construction paper, photo paper, or may be plastic, polymer, or cellulose products, such as, for example, transparency films, photographic film, or x-ray films. In yet other embodiments, substrate 201 is of metal composition using such metals as aluminum, steel, or other alloys. Other substrates 201 utilizing compounds comprised substantially of carbon, minerals, and other flexible and non-flexible materials capable of hosting printed text and/or images are used with some embodiments. Printing mechanism 203 may be, for example, an electrostatic drum such as those well known in the art and used in, for example, copiers, laser printers, and other printing devices. In one embodiment, printing mechanism 203 is an ink jet printing head. In yet other embodiments, printing mechanism 203 is a typewriter ribbon or dot matrix printing head. Ball roller 207 is used in some embodiments to track movement of substrate 201. The surface of ball roller 207 is selected to provide optimal contact and movement correlation with substrate 201. Ball roller 207 surface is patterned or quasi-patterned in certain embodiments. Motion sensor 204 may, for example, include light source 205 and sensor 206. In some embodiments, more than one motion sensor 204 is used to track ball roller 207 motion in more than one dimension.

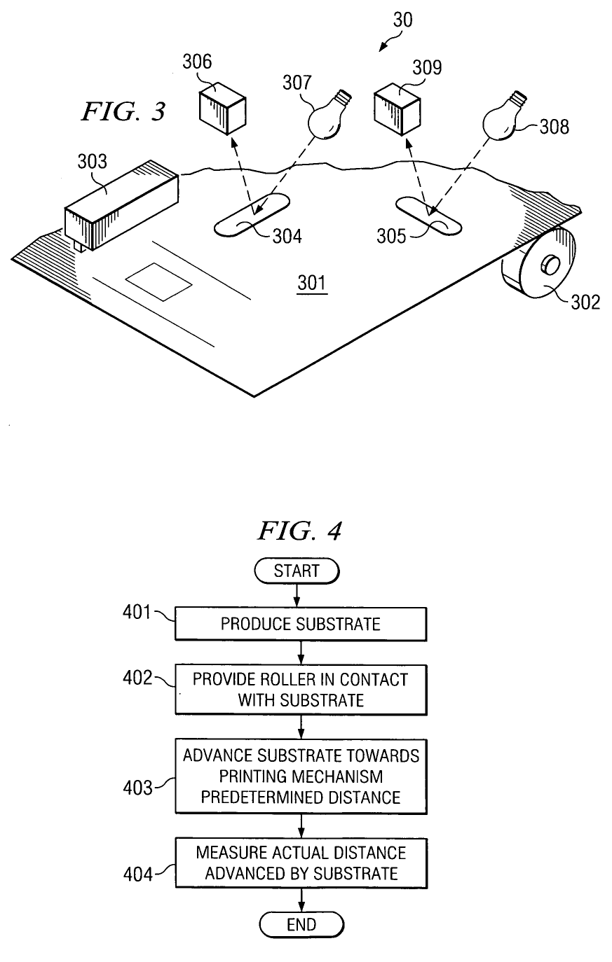

FIG. 3 is an illustration of an embodiment of the present invention. Substrate 301 of system 30 is fed into position under scanning head 303 by advancement mechanism 302. Advancement mechanism is, by way of example, a cylindrical roller or rollers, but may use alternate techniques, such as a cog or conveyor belt, to move substrate 201. Scanning head 303 is a discrete head component that moves in a direction perpendicular to the direction of substrate 301 advancement. Scanning head 303 in certain embodiments may also be an electrostatic drum as used in, for example, copiers, facsimile machines, et cetera. Scanning head 303 is used to convert text and/or images on substrate 301 into a digital or analog signal representative of the text and/or images. This signal may be stored or transmitted as is well known in the art. Two-axis rollers 304 and 305 are in contact with substrate 301 such that movement of substrate 301 results in corresponding movement of two-axis rollers 304 and 305. The movement of two-axis rollers 304, 305 are detected by sensors 306, 309 from changes in reflected light from light sources 307, 308. In some embodiments, a single motion sensor may be used for a plurality of rollers. Other embodiments use a treadmill roller.

FIG. 4 is a flow diagram of a method according to an embodiment of the present invention. Process 401 of method 40 provides a substrate as has been discussed herein.

Process 402 provides a roller in contact with the provided substrate. The surface of the roller is constructed to provide optimum contact with the substrate. The roller provided may be a roller as discussed herein, and a plurality of rollers are provided in some embodiments.

Process 403 advances the substrate towards the printing mechanism. In other embodiments, the substrate is advanced towards a scanning or other imaging mechanism. Substrate advancement may be effected by the process of step 402 or by additional rollers.

Process 404 measures the actual distance moved by the substrate by measuring the rotation of the roller using an optical motion sensor as discussed above. In some embodiments, the measured movement of the roller is compared to a predetermined rotation and the substrate position is adjusted until the measured roller rotation equals the predetermined rotation. In other embodiments, the printing mechanism is adjusted to compensate for any difference between the measured substrate position and the predetermined substrate position.

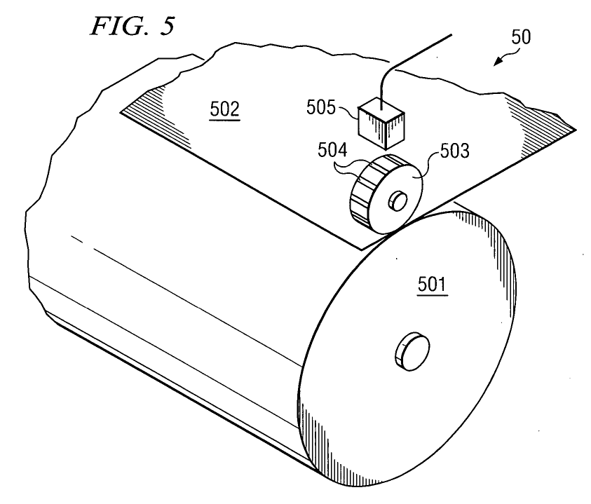

FIG. 5 is an illustration of an embodiment of the invention with a magnetic pattern recognition pickup. Tension roller 501 of system 50 is a cylindrical roller rotatable around its longitudinal axis in certain embodiments, and is similar to the tension roller 101 described in FIG. 1. Intermediate roller 503 is in constant contact with substrate 502 such that the surface of intermediate roller 503 moves at the same speed as does substrate 502. Intermediate roller 503 has a pattern of magnetic material 504 capable of emitting or modifying a magnetic field embedded in or attached to the surface. As the magnetic material 504 passes near magnetometer 505, magnetometer 505 is able to detect the motion of intermediate roller 503. A variety of magnetic material 504 are used, such as ferrous metals as iron, steel or alloys thereof. In some embodiments, intermediate roller 503 contains electromagnets as magnetic material 504 detectable by magnetometer 505.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A rendering system for accurately tracking the position of a substrate comprising:
means for creating rotational movement proportional to the movement of said substrate; and
means for optically reading said rotational movement.

2. The system of claim 1 wherein said means for creating rotational movement comprises a roller in contact with said substrate.

3. The system of claim 2 wherein said roller is selected from the group consisting of:
cylindrical roller, ball roller, two-axis roller, three-axis roller, single-axis roller, and treadmill roller.

4. The system of claim 2 wherein said roller is a roller having a pattern recognizable by optical means.

5. The system of claim 4 wherein said pattern is a quasi-periodic pattern.

6. The system of claim 2 wherein said roller is comprised of:
a surface finish selected for surface speed correspondence with said substrate.

7. The system of claim 1 wherein said system is selected from the group consisting of:
copier, printer, scanner, facsimile machine, typewriter, and plotter.

8. The system of claim 1 wherein said means for optically reading comprises a light source for illuminating.

9. The system of claim 8 wherein said light source comprises a laser light source.

10. The system of claim 1 further comprising:
means for rendering an image on said substrate.

11. The system of claim 10 wherein said image may be adjusted to match said optically read movement.

12. A system for rendering printed material comprising:
an advancement mechanism for advancing a substrate;
at least one roller operatively in contact with said substrate; and
at least one motion sensor for measuring the rotation of said at least one roller.

13. The system of claim 12 wherein said at least one roller comprises a roller selected from the group consisting of:
cylindrical roller, ball roller, two-axis roller, three-axis roller, single-axis roller, and treadmill roller.

14. The system of claim 12 wherein said at least one roller is a roller having a pattern recognizable by optical means.

15. The system of claim 14 wherein said pattern is a quasi-periodic pattern.

16. The system of claim 12 wherein said at least one roller is comprised of:
a surface finish selected for surface speed correspondence with said printing substrate.

17. The system of claim 12 wherein said at least one motion sensor comprises a light source for illuminating said at least one roller.

18. The system of claim 17 wherein said light source comprises a laser light source.

19. The system of claim 12 wherein said at least one motion sensor is a magnetometer.

20. A method for accurately tracking the position of a substrate comprising:
providing a substrate;
advancing said substrate towards a printing mechanism a predetermined distance;
measuring the actual distance advanced by said substrate using a motion sensor; and
adjusting the position of said substrate if the actual distance is not the same as the predetermined distance.

21. The method of claim 20 wherein said step of measuring comprises:
measuring the rotation of a roller in contact with said substrate using an optical motion sensor.

22. The method of claim 21 wherein said step of measuring comprises:
measuring the rotation of at least one roller with an optically recognizable pattern.

23. The method of claim 21 wherein said step of measuring comprises measuring the rotation of a roller selected from the group consisting of:
cylindrical roller, ball roller, two-axis roller, three-axis roller, single-axis roller, and treadmill roller.

24. The method of claim 20 wherein said step of measuring comprises the step of measuring using an optical motion sensor employing a laser light source.

25. The method of claim 20 wherein said step of measuring comprises:
measuring the motion of a roller in contact with said substrate using a magnetic motion sensor.
